(19) United States
(12) Patent Application Publication
(10) Pub. No.: US 2025/0111478 A1
(43) Pub. Date: Apr. 3, 2025

(54) SIGNAL PROCESSING APPARATUS, METHOD OF CONTROLLING SIGNAL PROCESSING APPARATUS, AND STORAGE MEDIUM

(71) Applicant: CANON KABUSHIKI KAISHA, Tokyo (JP)

(72) Inventor: TAKUYA KOSUGE, Kanagawa (JP)

(21) Appl. No.: 18/904,504

(22) Filed: Oct. 2, 2024

(30) Foreign Application Priority Data
Oct. 3, 2023 (JP) 2023-171952

(51) Int. Cl. G06T 5/50; G06T 5/70; G06T 11/00; G06V 10/60

(52) U.S. Cl. CPC G06T 5/50; G06T 5/70; G06T 11/001; G06V 10/60; G06T 2207/10024; G06T 2207/20221

(57) ABSTRACT

A signal processing apparatus includes one or more processors that function as a first acquisition unit configured to acquire image data obtained by capturing an image of an object and a background video image displayed on a background display, an extraction unit configured to extract information on a background video image area and information on an object area in the image data, a first generation unit configured to generate a first colored image in which an area including a first frequency component of the image data on the background video image area is colored with a specific color, a second generation unit configured to generate a second colored image in which an area including a second frequency component of the image data on the object area is colored with a specific color, and a combination unit configured to combine the first and second colored images and output combined image data.

### BACKGROUND

### Field of the Disclosure

The present disclosure relates to a signal processing apparatus, a method of controlling the signal processing apparatus, and a storage medium.

### Description of the Related Art

A virtual production by in-camera virtual effects (VFX) using a light-emitting diode (LED) wall has been becoming popular. The LED wall is a display apparatus in which LEDs are arranged in a lattice shape. In the in-camera VFX, a previously-captured image is displayed on the LED wall, a performer and an art set are disposed between the LED wall and a camera, and the LED wall, the performer, and the art set are imaged. In an image captured by the in-camera VFX, a partial area where the performer and the art set are imaged is referred to as a real area (object area), and a partial area where the LED wall is imaged is referred to as a virtual area (background video-image area).

An image of the virtual area is an image obtained by displaying an image captured by a first camera on the LED wall and capturing the displayed image by a second camera again, whereas an image of the real area is an image directly captured by the second camera.

If the LED wall is erroneously in focus, moire easily occurs. On the other hand, it is necessary to precisely focus on an object such as the performer and the art set. Accordingly, in the virtual production, it is desirable to separately observe a focusing state of the virtual area and a focusing state of the real area.

For example, Japanese Patent Application Laid-Open No. 2016-219920 discusses a technique for performing peaking processing only on an object having distance information substantially same as distance information on a specific object in an image.

By the method discussed in Japanese Patent Application Laid-Open No. 2016-219920, the peaking processing can be performed on the partial area. However, the virtual area and the real area cannot be intuitively distinguished, and features of each of the areas cannot be grasped because the virtual area and the real area are not considered.

### SUMMARY

The present disclosure has been made in consideration of the above situation, and is directed to a signal processing apparatus and a method of controlling the signal processing apparatus that can easily analyze a virtual area and a real area separately, and that are suitable for virtual production.

According to an aspect of the present disclosure, a signal processing apparatus includes one or more processors that execute a program stored in a memory and thereby function as a first acquisition unit configured to acquire image data obtained by capturing an image of an object and a background video image displayed on a background display by an imaging apparatus, an extraction unit configured to extract information on a background video image area and information on an object area in the image data, a first generation unit configured to generate a first colored image in which an area including a first frequency component of the image data on the background video image area is colored with a specific color indicating the area including the first frequency component, a second generation unit configured to generate a second colored image in which an area including a second frequency component of the image data on the object area is colored with a specific color indicating the area including the second frequency component, and a combination unit configured to combine the first colored image and the second colored image and to output combined image data.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a signal processing apparatus according to one or more aspects of the present disclosure.

FIG. 2 is a block diagram illustrating a configuration example of an imaging apparatus according to one or more aspects of the present disclosure.

FIG. 3 is a block diagram illustrating an example of connection of apparatuses according to one or more aspects of the present disclosure.

FIG. 4 is a diagram illustrating imaging outline of in-camera virtual effects (VFX) as viewed from an overhead viewpoint according to one or more aspects of the present disclosure.

FIG. 5 is a diagram illustrating an example of captured moving image data according to one or more aspects of the present disclosure.

FIG. 6 is a diagram illustrating a display example of combined moving image data according to one or more aspects of the present disclosure.

FIG. 7 is a diagram illustrating luminance distribution in an example of captured moving image data according to one or more aspects of the present disclosure.

FIGS. 8A and 8B are tables illustrating colors of false color displays associated with luminance of the captured moving image data according to one or more aspects of the present disclosure.

FIG. 9 is a diagram illustrating an example of displaying combined moving image data according to one or more aspects of the present disclosure.

FIG. 10 is a block diagram illustrating a configuration example of a signal processing apparatus according to one or more aspects of the present disclosure.

### DESCRIPTION OF THE EMBODIMENTS

Some preferred exemplary embodiments of the present disclosure are to be described in detail with reference to accompanying drawings.

### Configuration of Signal Processing Apparatus

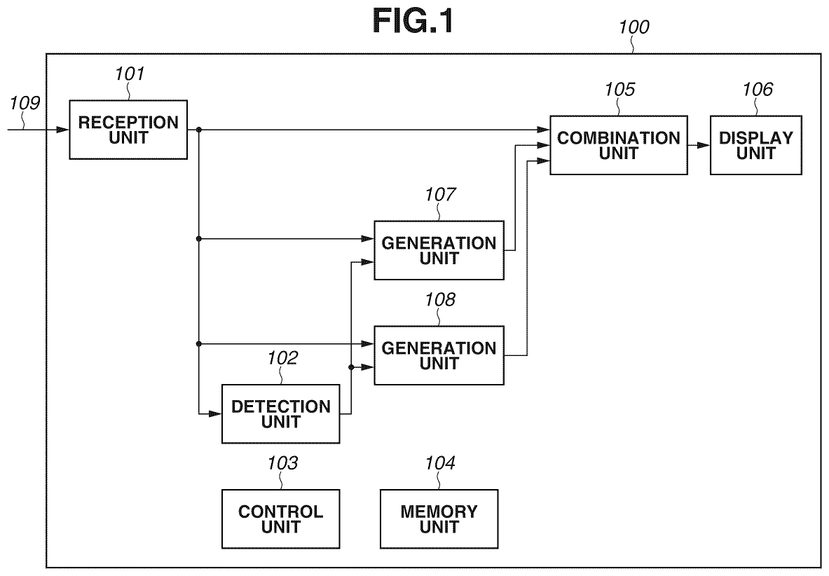

A first exemplary embodiment is to be described. FIG. 1 is a block diagram illustrating a configuration example of a signal processing apparatus according to the present exemplary embodiment. A signal processing apparatus 100 illustrated in FIG. 1 includes a reception unit 101, a detection unit 102, a control unit 103, a memory unit 104, a combination unit 105, a display unit 106, a generation unit 107, and a generation unit 108.

The reception unit 101 acquires captured moving image data 109, and outputs the moving image data to the detection unit 102, the combination unit 105, the generation unit 107, and the generation unit 108. In the present exemplary embodiment, the reception unit 101 acquires image data for each frame of a moving image from an external apparatus. The reception unit 101 outputs the acquired image data to each of the units on a subsequent stage. The reception unit 101 is an input terminal complying with a standard such as serial digital interface (SDI) and high-definition multimedia interface (HDMI®). The external apparatus is an imaging apparatus, a reproduction apparatus, or the like. In the present exemplary embodiment, an example of connection with an imaging apparatus 200 is to be described, and details thereof are to be described below.

The detection unit 102 acquires the moving image data including area information that is output from the reception unit 101, and outputs the acquired area information to the control unit 103, the generation unit 107, and the generation unit 108. The area information is to be described below.

The control unit 103 controls processing in each of the units of the signal processing apparatus 100. The control unit 103 is connected to each of the units through a control bus, but the control bus is not illustrated because of complication. For example, the control unit 103 is a calculation processing circuit for controlling processing in each of the units of the signal processing apparatus 100 by executing programs stored in the memory unit 104. In the present exemplary embodiment, the control unit 103 controls the combination unit 105 based on the area information output from the detection unit 102.

The memory unit 104 stores programs, parameters, and the like. The programs and the parameters stored in the memory unit 104 are read and written by each of the units of the signal processing apparatus 100.

The combination unit 105 combines a first peaking display output from the generation unit 107 and a second peaking display output from the generation unit 108 with the moving image data based on control contents output from the control unit 103, thereby generating combined moving image data. The combination unit 105 outputs the combined moving image data to the display unit 106.

The display unit 106 displays a moving image based on the combined moving image data output from the combination unit 105, on a display surface. The display unit 106 is, for example, a display panel including a liquid crystal panel and a backlight unit, or an organic electroluminescent (EL) display panel.

The generation unit 107 acquires the moving image data output from the reception unit 101 and the area information output from the detection unit 102, and generates a peaking display (first peaking display) relating to pixels of the moving image data designated as a virtual area by the area information. More specifically, the generation unit 107 extracts data for one frame from the moving image data, performs object edge detection on signals of the pixels designated as the virtual area based on an edge detection frequency band, and generates an analysis result as the first peaking display. As a result, a display image including a colored image in which an area including a predetermined frequency component of the display image is colored with a specific color that indicates the area including the predetermined frequency component can be created.

The generation unit 108 acquires the moving image data output from the reception unit 101 and the area information output from the detection unit 102, and generates a peaking display (second peaking display) relating to pixels of the moving image data designated as a real area by the area information. More specifically, the generation unit 108 extracts data for one frame from the moving image data, performs object edge detection on signals of the pixels designated as the real area based on the edge detection frequency band, and generates an analysis result as the second peaking display.

A procedure of integrating the above-described operation of the units to display the first peaking display and the second peaking display on the display unit 106 is to be described. When the reception unit 101 receives the captured moving image data 109, the detection unit 102 extracts the area information from the moving image data, and outputs the area information to the control unit 103, the generation unit 107, and the generation unit 108. The generation unit 107 and the generation unit 108 respectively generate the first peaking display and the second peaking display with reference to the area information. The combination unit 105 combines the first peaking display and the second peaking display with the moving image data to generate the combined moving image data, and outputs the combined moving image data to the display unit 106. The display unit 106 displays the combined moving image data including the first peaking display and the second peaking display.

### Configuration of Imaging Apparatus

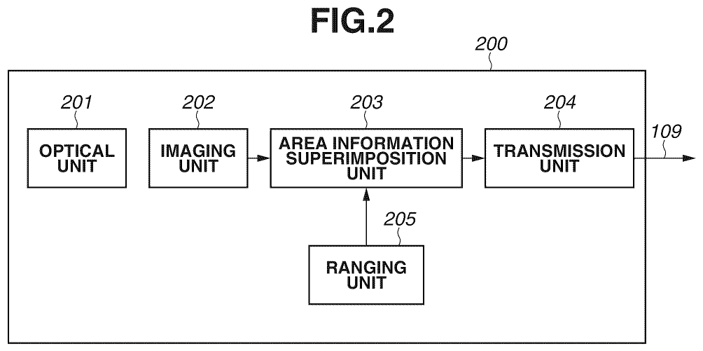

FIG. 2 is a block diagram illustrating a configuration example of an imaging apparatus generating the captured moving image data to be acquired by the signal processing apparatus according to the present exemplary embodiment. An imaging apparatus 200 illustrated in FIG. 2 includes an optical unit 201, an imaging unit 202, an area information superimposition unit 203, a transmission unit 204, and a ranging unit 205

The optical unit 201 includes a lens and a focus motor, and forms an image of an imaging object on the imaging unit 202. The imaging unit 202 includes an image sensor, generates moving image data from the image formed by the optical unit 201, and outputs the moving image data to the area information superimposition unit 203. The area information superimposition unit 203 superimposes area information on the moving image data, and outputs the resultant moving image data to the transmission unit 204. The area information is to be described below. The transmission unit 204 transmits the moving image data received from the area information superimposition unit 203 as the captured moving image data 109. The transmission unit 204 is an output terminal complying with a standard such as SDI and HDMI®. The ranging unit 205 measures a distance between the imaging apparatus 200 and the imaging object for each of the pixels on an image sensor. The distances measured by the ranging unit 205 are used for generation of the area information, and details thereof are to be described below. A technique in which a pixel detecting a phase difference is disposed on the image sensor to measure a distance is known. In this case, the imaging unit 202 and the ranging unit 205 are integrated.

### Example of Connection of Apparatuses

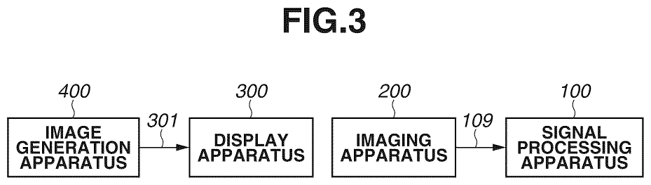

FIG. 3 is a block diagram illustrating an example of connection of an image generation apparatus, a display apparatus, the imaging apparatus, and the signal processing apparatus. An image generation apparatus 400 previously internally stores the captured moving image data, and generates moving image data by reproducing the captured moving image data. The image generation apparatus 400 outputs the generated moving image data as generated moving image data 301 to a display apparatus 300. The display apparatus 300 is a light-emitting diode (LED) wall, and is a background display displaying the generated moving image data 301 (background video-image data). The imaging apparatus 200 outputs captured moving image data as the captured moving image data 109 to the signal processing apparatus 100.

### Imaging Outline as Viewed From Overhead Viewpoint

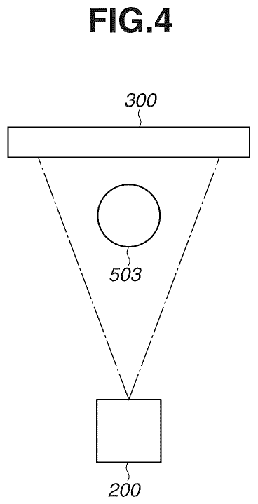

FIG. 4 is a diagram illustrating imaging outline of in-camera virtual effects (VFX) as viewed from an overhead viewpoint. A performer 503 gives a performance between the display apparatus 300 and the imaging apparatus 200. The imaging apparatus 200 images the display apparatus 300 and the performer 503. Alternate long and short dash lines indicate an angle of view of the optical unit 201. FIG. 4 illustrates a case where an object to be imaged is one performer, but the object to be imaged may be a plurality of performers, and an art set may be provided in addition to the performer. A background video image is displayed on the display apparatus 300 and is captured by the imaging apparatus 200.

### Area Information for Identification of Real Area and Virtual Area

The area information is to be described. The area information is information for identifying whether each of the pixels is in the real area or the virtual area. The area information superimposition unit 203 imparts the area information while the pixels each having the distance measured by the ranging unit 205 substantially coincident with the distance between the imaging apparatus 200 and the display apparatus 300 are handled as the pixels in the virtual area, and the other pixels are handled as the pixels in the real area. The distance between the imaging apparatus 200 and the display apparatus 300 is measured by a user of the imaging apparatus 200 and the display apparatus 300, and is set to the imaging apparatus 200. The area information is superimposed as metadata on the moving image data. Examples of the metadata include ancillary (ANC) data standardized by SDI, and InfoFrame standardized by HDMI®. In a case of the ANC data, optional binary data can be superimposed on a horizontal blanking period. Although a specific superimposition method of the area information is not standardized, the area information can be superimposed using the ANC data in the following manner. It is assumed that one pixel in the virtual area is indicated by one-bit value 1, and one pixel in the real area is indicated by one-bit value 0. Data collecting the values (1 or 0) of the pixels in one line is generated, and the data is superimposed as the ANC data on the horizontal blanking period of the corresponding line.

### Example of Captured Moving Image Data

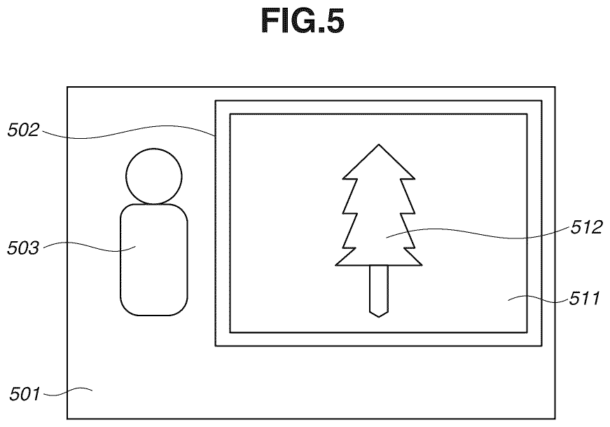

FIG. 5 is a diagram illustrating an example of the captured moving image data 109. A wall 501 and a window frame 502 are included in an art set. The performer 503 is positioned in front of the wall 501 of the art set. An outer scenery 511 and a standing tree 512 are positioned inside the window frame 502. The outer scenery 511 and the standing tree 512 are previously imaged and displayed on the display apparatus 300. When the wall 501, the window frame 502, the performer 503, and the display apparatus 300 are imaged in that state, the captured moving image data illustrated in FIG. 5 is acquired. The wall 501, the window frame 502, and the performer 503 are included in the real area. The outer scenery 511 and the standing tree 512 are included in the virtual area.

### Example of Combined Moving Image Data Displayed by Display Unit (Peaking Display)

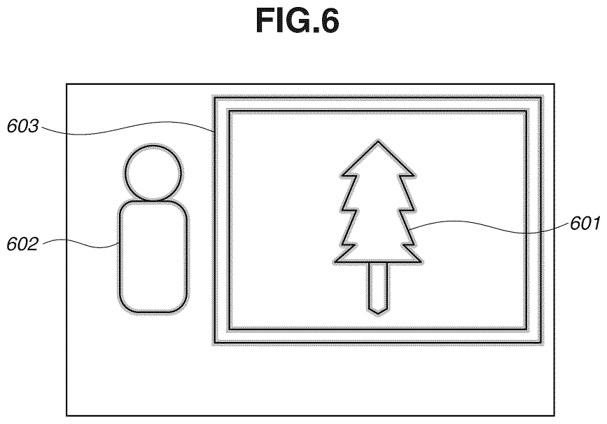

FIG. 6 is a diagram illustrating an example of the combined moving image data displayed by the display unit 106. The generation unit 107 generates the first peaking display (peaking display of virtual area) in a first display mode. The generation unit 108 generates the second peaking display (peaking display of real area) in a second display mode different from the first display mode. In the example illustrated in FIG. 6, the first display mode is illustrated with pale gray, and the second display mode is illustrated with dark gray. The standing tree 512 is an imaging object in the virtual area. Accordingly, the peaking display of the standing tree 512 is performed in the first display mode (pale gray) by the generation unit 107 (reference numeral 601). The performer 503 is an imaging object in the real area. Accordingly, the peaking display of the performer 503 is performed in the second display mode (dark gray) by the generation unit 108 (reference numeral 602). The window frame 502 is an imaging object in the real area but is positioned at a boundary with the virtual area. Accordingly, the peaking display of the boundary on the virtual area side is performed in the first display mode (pale gray) by the generation unit 107, whereas the peaking display of the boundary on the real area side is performed in the second display mode (dark gray) by the generation unit 108 (reference numeral 603).

The first peaking display and the second peaking display are combined with the captured moving image data illustrated in FIG. 5, which results in the combined moving image data illustrated in FIG. 6. The combined moving image data illustrated in FIG. 6 is displayed by the display unit 106.

### Effects by Present Exemplary Embodiment

According to the present exemplary embodiment, it is possible to separately and conveniently apply the peaking display to the virtual area and the real area, and to provide a guide display that enables intuitive distinction of the virtual area and the real area and enables grasping of the focusing state of each of the areas.

A modification is to be described. In the present exemplary embodiment, the example in which the signal processing apparatus 100 receives the moving image data is to be described, but the signal processing apparatus 100 may receive still image data. In a case of the moving image, the reception unit 101 acquires frame data for each frame of the moving image, whereas in a case of the still image, the reception unit 101 newly acquires the still image data and generates and displays the combined image data every time the still image data is changed.

In the present exemplary embodiment, the example in which the display unit 106 displays the combined moving image data is to be described. The combined moving image data may be output to outside by using SDI or HDMI.

The generation unit 107 and the generation unit 108 generate the peaking displays by displaying high-frequency components of a spatial frequency of the moving image data in the first display mode and the second display mode, respectively. At this time, the generation unit 107 preferably extracts the high-frequency components of the spatial frequency up to a lower frequency side, as compared with the generation unit 108. For example, the generation unit 107 extracts components of the spatial frequency of 1/16 or more of a sampling frequency as targets of the peaking display, whereas the generation unit 108 extracts components of the spatial frequency of ¼ or more of the sampling frequency as targets of the peaking display. As a result, the first peaking display that is the peaking display of the virtual area covers the lower frequency as compared with the second peaking display that is the peaking display of the real area. Since the moving image data on the virtual area is generated by imaging the LED wall, there is a concern about moire caused by pixels of the LED wall. In the virtual area, the lower frequency is covered by the peaking display, which makes it possible to reduce moire caused by focusing on the LED wall against intention of the user.

An operation unit for the user to independently set the spatial frequencies targeted by the peaking displays of the generation unit 107 and the generation unit 108 may be provided. The spatial frequency at which there is a concern about occurrence of moire is different depending on the number of pixels of the imaging apparatus and the LED wall. Accordingly, the user sets the appropriate spatial frequencies, which makes it possible to reduce moire caused by focusing on the LED wall against intention of the user.

When the number of the frequency components as the targets of the peaking display by the generation unit 107 is a predetermined value or more, the signal processing apparatus 100 may notify the imaging apparatus 200 of an instruction, and processing for opening a diaphragm of the optical unit 201 may be performed. Opening the diaphragm makes it possible to reduce moire caused by focusing on the LED wall. Although not illustrated in FIG. 3, the signal processing apparatus 100 and the imaging apparatus 200 can perform communication through a local area network (LAN). The diaphragm is opened in a case where the number of the frequency components as the targets of the peaking display extracted by the generation unit 107 is a certain value or more. For example, the diaphragm is opened in a case where the number of pixels as targets of the peaking display is 10% or more of the number of pixels of the virtual area.

When the generation unit 107 extracts the frequency components as the targets of the peaking display, the signal processing apparatus 100 may notify the image generation apparatus 400 of an instruction, and blurring processing may be performed on the generated moving image data 301. For example, the blurring processing is processing for performing low-pass filter processing to reduce the high-frequency components. Performing the blurring processing makes it possible to reduce moire caused by focusing on the LED wall. Although not illustrated in FIG. 3, the signal processing apparatus 100 and the image generation apparatus 400 can perform communication through a LAN. The high-frequency components are reduced in the case where the number of frequency components as the targets of the peaking display extracted by the generation unit 107 is a certain value or more. For example, the high-frequency components are reduced in the case where the number of pixels as the targets of the peaking display is 10% or more of the number of pixels of the virtual area.

To facilitate confirmation of a focusing state on the LED wall, an LED-wall focusing-state confirmation image may be displayed. In this case, the present exemplary embodiment is preferably applied in a manner to be described below. The signal processing apparatus 100 has a configuration in which an enabled state and a disabled state of the peaking display are switchable. The signal processing apparatus 100 transmits an instruction to the image generation apparatus 400, and the image generation apparatus 400 outputs a focusing confirmation image as the generated moving image data 301. The focusing confirmation image is, for example, an image in which a white horizontal-direction line and a white vertical-direction line are added to a black background.

The signal processing apparatus 100 switches the peaking display to the enabled state. The display apparatus 300 displays the focusing confirmation image. The imaging apparatus 200 images the display apparatus 300 displaying the focusing confirmation image. Further, the signal processing apparatus 100 performs the peaking display on the captured moving image data 109 that is generated by imaging the display apparatus 300 displaying the focusing confirmation image. The focusing state on the LED wall can be known by checking the first peaking display performed on the focusing confirmation image. Although not illustrated in FIG. 3, the signal processing apparatus 100 and the image generation apparatus 400 can perform communication through a LAN.

A second exemplary embodiment of the present disclosure is to be described. The present exemplary embodiment is a modification of the first exemplary embodiment. Accordingly, differences from the first exemplary embodiment are mainly described, and contents similar to the first exemplary embodiment are appropriately omitted.

### Configuration of Signal Processing Apparatus

The reception unit 101, the detection unit 102, the control unit 103, the memory unit 104, and the display unit 106 are similar to those according to the first exemplary embodiment.

In the first exemplary embodiment, the combination unit 105 combines the first peaking display and the second peaking display with the moving image data, thereby generating the combined moving image data. In the second exemplary embodiment, the combination unit 105 combines a first false color display and a second false color display with the moving image data, thereby generating combined moving image data. In the first exemplary embodiment, the generation unit 107 and the generation unit 108 respectively generate the first peaking display and the second peaking display, whereas in the second exemplary embodiment, the generation unit 107 and the generation unit 108 respectively generate the first false color display and the second false color display. Details thereof are to be described below.

The combination unit 105 combines the first false color display output from the generation unit 107 and the second false color display output from the generation unit 108 with the moving image data based on control contents output from the control unit 103, thereby generating combined moving image data. The combination unit 105 outputs the combined moving image data to the display unit 106.

The generation unit 107 acquires the moving image data output from the reception unit 101 and the area information output from the detection unit 102. The generation unit 107 generates a false color display (first false color display) relating to pixels of the moving image data designated as the virtual area by the area information. More specifically, the generation unit 107 extracts data for one frame from the moving image data, performs processing for converting a gradation value of each of the pixels such that each of the pixels is displayed with a predetermined color based on luminance of the pixels designated as the virtual area, and generates a result thereof as the first false color display. As a result, a display image including a colored image in which an area having a predetermined luminance level of the display image is colored with a specific color that indicates the area having the predetermined luminance level can be created.

The generation unit 108 acquires the moving image data output from the reception unit 101 and the area information output from the detection unit 102. The generation unit 108 generates a false color display (second false color display) relating to pixels of the moving image data designated as the real area by the area information. More specifically, the generation unit 108 extracts data for one frame from the moving image data, performs processing for converting a gradation value of each of the pixels such that each of the pixels is displayed with a predetermined color based on luminance of the pixels designated as the real area, and generates a result thereof as the second false color display.

A procedure of integrating the above-described operation of the units to display the first false color display and the second false color display on the display unit 106 is to be described. When the reception unit 101 receives the captured moving image data 109, the detection unit 102 extracts the area information from the moving image data, and outputs the area information to the control unit 103, the generation unit 107, and the generation unit 108. The generation unit 107 and the generation unit 108 respectively generate the first false color display and the second false color display with reference to the area information. The combination unit 105 combines the first false color display and the second false color display with the moving image data to generate the combined moving image data, and outputs the combined moving image data to the display unit 106. The display unit 106 displays the combined moving image data including the first false color display and the second false color display.

### Luminance Distribution in Example of Captured Moving Image Data

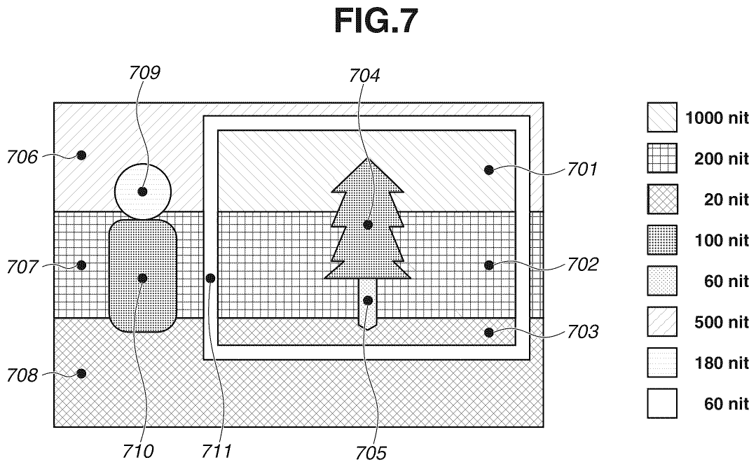

FIG. 7 is a diagram illustrating luminance distribution in the example of the captured moving image data 109 illustrated in FIG. 5.

A luminance of an upper part of the outer scenery 511 is 1000 nit (reference numeral 701), a luminance of a middle part is 200 nit (reference numeral 702), and a luminance of a lower part is 20 nit (reference numeral 703). A luminance of an upper part of the standing tree 512 is 100 nit (reference numeral 704), and a luminance of a lower part is 60 nit (reference numeral 705). A luminance of an upper part of the wall 501 is 500 nit (reference numeral 706), a luminance of a middle part is 200 nit (reference numeral 707), and a luminance of a lower part is 20 nit (reference numeral 708). A luminance of an upper part of the performer 503 is 180 nit (reference numeral 709), and a luminance of a lower part is 100 nit (reference numeral 710). A luminance of the window frame 502 is 60 nit (reference numeral 711).

### Table of Colors of False Color Display Associated With Luminances of Captured Moving Image Data

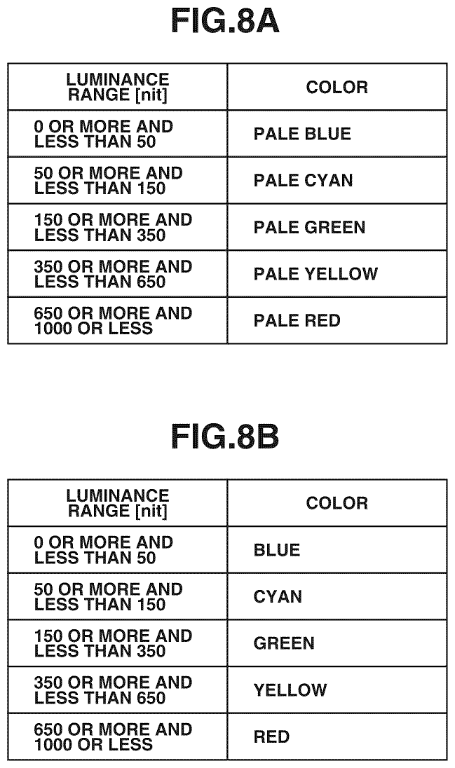

FIG. 8A is a table illustrating colors of the false color display associated with the luminances of the captured moving image data when the generation unit 107 generates the first false color display. FIG. 8B is a table illustrating colors of the false color display associated with the luminances of the captured moving image data when the generation unit 108 generates the second false color display. A luminance range of the captured moving image data is 0 nit or more and 1000 nit or less.

### Example of Combined Moving Image Data Displayed by Display Unit (False Color Display)

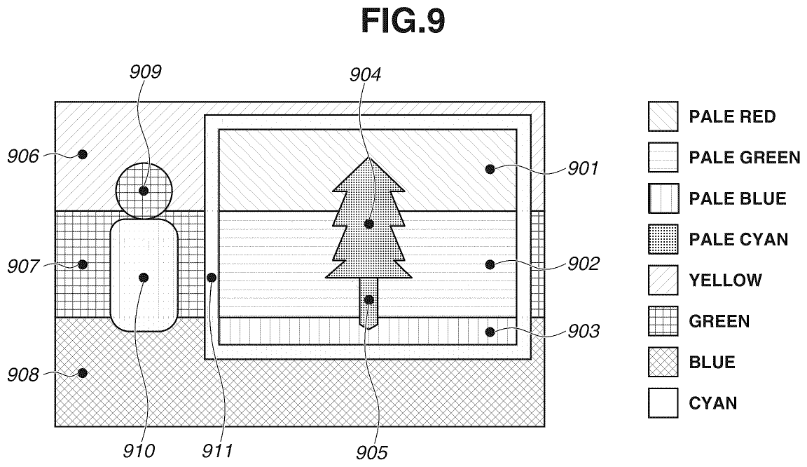

FIG. 9 is a diagram illustrating an example of the combined moving image data displayed by the display unit 106. The combined moving image data illustrated in FIG. 9 is obtained by combining the first false color display and the second false color display with the captured moving image data illustrated in FIG. 5. The combined moving image data illustrated in FIG. 9 is displayed by the display unit 106.

Because the outer scenery 511 and the standing tree 512 are imaging objects in the virtual area, the outer scenery 511 and the standing tree 512 are colored with the first false color display generated by the generation unit 107 based on the table illustrated in FIG. 8A. The upper part of the outer scenery 511 having the luminance of 1000 nit is colored with pale red (reference numeral 901), the middle part having the luminance of 200 nit is colored with pale green (reference numeral 902), and the lower part having the luminance of 20 nit is colored with pale blue (reference numeral 903). The upper part of the standing tree 512 having the luminance of 100 nit is colored with pale cyan (reference numeral 904), and the lower part having the luminance of 60 nit is colored with pale cyan (reference numeral 905).

Since the wall 501, the window frame 502, and the performer 503 are imaging objects in the real area, the wall 501, the window frame 502, and the performer 503 are colored with the second false color display generated by the generation unit 108 based on the table illustrated in FIG. 8B. The upper part of the wall 501 having the luminance of 500 nit is colored with yellow (reference numeral 906), the middle part having the luminance of 200 nit is colored with green (reference numeral 907), and the lower part having the luminance of 20 nit is colored with blue (reference numeral 908). The upper part of the performer 503 having the luminance of 180 nit is colored with green (reference numeral 909), and the lower part having the luminance of 100 nit is colored with cyan (reference numeral 910). The window frame 502 having the luminance of 60 nit is colored with cyan (reference numeral 911).

The virtual area is colored based on the table illustrated in FIG. 8A, and the real area is colored based on the table illustrated in FIG. 8A. As a result, a portion of the virtual area and a portion of the real area having the same luminance are colored with colors having the same hue and different densities.

### Effects by Present Exemplary Embodiment

According to the present exemplary embodiment, it is possible to separately and conveniently apply the false color display to the virtual area and the real area, and changing the densities of the colors used for coloring enables intuitive distinction of the virtual area and the real area and enables grasping of the luminances of the areas. The colors having the same hue are used for the same luminance in coloring, which enables intuitive grasping of a portion of the virtual area and a portion of the real area having the luminances close to each other.

A modification is to be described. In the present exemplary embodiment, the example in which the luminance range of the moving image data of 0 nit or more and 1000 nit or less is colored with any of the colors based on the tables illustrated in FIGS. 8A and 8B is to be described. However, a part of the luminance range may not be colored. For example, the luminance range of 0 nit or more and less than 50 nit may not be colored, and the moving image data itself may be displayed by the display unit 106.

A third exemplary embodiment of the present disclosure is to be described. The present exemplary embodiment is a modification of the first and second exemplary embodiments. Accordingly, differences from the first and second exemplary embodiments are mainly described, and contents similar to the first and second exemplary embodiments are appropriately omitted.

### Configuration of Signal Processing Apparatus

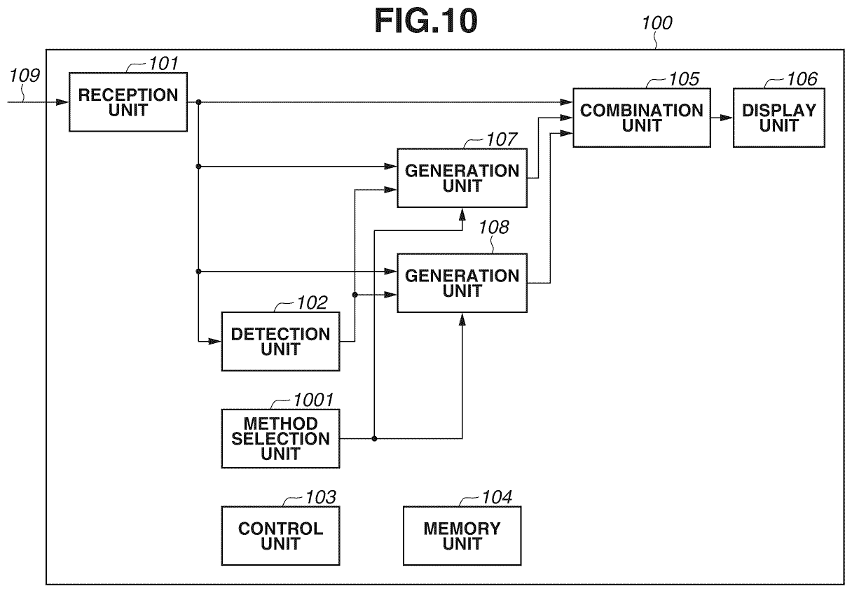

FIG. 10 is a block diagram illustrating a configuration example of a signal processing apparatus according to the present exemplary embodiment.

The combination unit 105 combines the first peaking display or the first false color display, and the second peaking display or the second false color display with the moving image data based on control contents output from the control unit 103, thereby generating combined moving image data. The combination unit 105 outputs the combined moving image data to the display unit 106.

The generation unit 107 acquires the moving image data output from the reception unit 101 and the area information output from the detection unit 102. The generation unit 107 generates the peaking display (first peaking display) or the false color display (first false color display) relating to pixels of the moving image data designated as the virtual area by the area information. More specifically, the generation unit 107 extracts data for one frame from the moving image data, further extracts the pixels designated as the vertical area from the data, and generates an analysis result as the first peaking display or the first false color display. Further, the generation unit 107 selects and generates the first peaking display or the first false color display based on a notification from a method selection unit 1001.

The generation unit 108 acquires the moving image data output from the reception unit 101 and the area information output from the detection unit 102. The generation unit 108 generates the peaking display (second peaking display) or the false color display (second false color display) relating to pixels of the moving image data designated as the real area by the area information. More specifically, the generation unit 108 extracts data for one frame from the moving image data, further extracts the pixels designated as the real area from the data, and generates an analysis result as the second peaking display or the second false color display. Further, the generation unit 108 selects and generates the second peaking display or the second false color display based on a notification from the method selection unit 1001.

The method selection unit 1001 selects the peaking display or the false color display in response to operation by the user, and notifies the generation unit 107 and the generation unit 108 of the selected display.

When the method selection unit 1001 selects the peaking display, the generation unit 107 generates the first peaking display, and the generation unit 108 generates the second peaking display. The combination unit 105 combines the first peaking display and the second peaking display, and the display unit 106 performs display.

When the method selection unit 1001 selects the false color display, the generation unit 107 generates the first false color display, and the generation unit 108 generates the second false color display. The combination unit 105 combines the first false color display and the second false color display, and the display unit 106 performs display.

### Effects by Present Exemplary Embodiment

According to the present exemplary embodiment, the peaking display or the false color display is selected in response to operation by the user. Accordingly, it is possible to visualize features demanded by the user. This enables grasping of features of the virtual area and the real area. Thus, confirmation of a difference in image quality between the virtual area and the real area, and adjustment of image quality are easily performable.

A fourth exemplary embodiment of the present disclosure is to be described. The present exemplary embodiment is a modification of the first to third exemplary embodiments. Accordingly, differences with the first to third exemplary embodiments are mainly described, and contents similar to the first to third exemplary embodiments are appropriately omitted.

### Out-of-Color Gamut Alert Display

The examples in which the peaking display and the false color display are applied to the exemplary embodiments are described above. The exemplary embodiments can be applied to other image analysis methods. For example, the exemplary embodiments can be applied to an out-of-color gamut alert display. The out-of-color gamut alert display is an image analysis method in which, when the pixel of the captured moving image data has chromaticity outside a predetermined color gamut (e.g., color gamut standardized by ITU-R BT. 709), a color or brightness of the pixel is changed and displayed. The pixel outside the color gamut is displayed in different modes, for example, with red in the virtual area and with blue in the real area.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-171952, filed Oct. 3, 2023, which is hereby incorporated by reference herein in its entirety.

What is claimed is:

1. A signal processing apparatus comprising:
one or more processors that execute a program stored in a memory and thereby function as:
a first acquisition unit configured to acquire image data obtained by capturing an image of an object and a background video image displayed on a background display by an imaging apparatus;
an extraction unit configured to extract information on a background video image area and information on an object area in the image data;
a first generation unit configured to generate a first colored image in which an area including a first frequency component of the image data on the background video image area is colored with a specific color indicating the area including the first frequency component;
a second generation unit configured to generate a second colored image in which an area including a second frequency component of the image data on the object area is colored with a specific color indicating the area including the second frequency component; and
a combination unit configured to combine the first colored image and the second colored image and to output combined image data.

2. The signal processing apparatus according to claim 1, wherein the first frequency component is less in frequency than the second frequency component.

3. The signal processing apparatus according to claim 1, wherein the specific color is different between the first generation unit and the second generation unit.

4. The signal processing apparatus according to claim 1, wherein each of the first generation unit and the second generation unit generates a peaking display.

5. The signal processing apparatus according to claim 4, wherein the one or more processors further function as a notification unit configured, in a case where a number of pixels as targets of the peaking display generated by the first generation unit is a predetermined value or more, to notify the imaging apparatus of an instruction of processing for opening a diaphragm.

6. The signal processing apparatus according to claim 4, wherein the one or more processors further function as a notification unit configured, in a case where a number of pixels as targets of the peaking display generated by the first generation unit is a predetermined value or more, to notify an image generation apparatus configured to generate background video image data of an instruction of blurring processing.

7. The signal processing apparatus according to claim 4, wherein the one or more processors further function as a notification unit configured to notify an image generation apparatus configured to generate background video image data of an instruction for displaying a focusing confirmation image.

8. The signal processing apparatus according to claim 1, wherein the one or more processors further function as a control unit configured to control a display unit to display the combined image data output from the combination unit.

9. A signal processing apparatus comprising:
one or more processors that execute a program stored in a memory and thereby function as:
a first acquisition unit configured to acquire image data obtained by capturing an image of an object and a background video image displayed on a background display by an imaging apparatus;
an extraction unit configured to extract information on a background video image area and information on an object area in the image data;
a first generation unit configured to generate a first colored image in which an area having a predetermined luminance level in a display image of the image data on the background video image area is colored with a specific color indicating the area having the predetermined luminance level;
a second generation unit configured to generate a second colored image in which an area having a predetermined luminance level in a display image of the image data on the object area is colored with a specific color indicating the area having the predetermined luminance level; and
a combination unit configured to combine the first colored image and the second colored image and to output combined image data.

10. The signal processing apparatus according to claim 9, wherein the specific color of the first generation unit and the specific color of the second generation unit for pixels having a same luminance in the image data have same hue and different densities.

11. The signal processing apparatus according to claim 9, wherein each of the first generation unit and the second generation unit generates a false color display.

12. A signal processing apparatus comprising:
one or more processors that execute a program stored in a memory and thereby function as:
a first acquisition unit configured to acquire image data obtained by capturing an image of an object and a background video image displayed on a background display by an imaging apparatus;
an extraction unit configured to extract information on a background video image area and information on an object area in the image data;
a first generation unit configured, when a pixel of the image data on the background video image area has chromaticity outside a predetermined color gamut, to change a color or brightness of the pixel;
a second generation unit configured, when a pixel of the image data on the object area has chromaticity outside a predetermined color gamut, to change a color or brightness of the pixel; and
a combination unit configured to combine image data output from the first generation unit and image data output from the second generation unit and to output combined image data.

13. The signal processing apparatus according to claim 12, wherein each of the first generation unit and the second generation unit generates an out-of-color gamut alert display.

14. A method of controlling a signal processing apparatus, the method comprising:
acquiring image data obtained by capturing an image of an object and a background video image displayed on a background display by an imaging apparatus;
extracting information on an object area and information on a background video image area in the image data;
generating a first colored image in which an area including a first frequency component of the image data on the background video image area is colored with a specific color indicating the area including the first frequency component;
generating a second colored image in which an area including a second frequency component of the image data on the object area is colored with a specific color indicating the area including the second frequency component; and
combining the first colored image and the second colored image and outputting combined image data.

15. A method of controlling a signal processing apparatus, the method comprising:
acquiring image data obtained by capturing an image of an object and a background video image displayed on a background display by an imaging apparatus;
extracting information on an object area and information on a background video image area in the image data;
generating a first colored image in which an area having a predetermined luminance level in a display image of the image data on the background video image area is colored with a specific color indicating the area having the predetermined luminance level;
generating a second colored image in which an area having a predetermined luminance level in a display image of the image data on the object area is colored with the specific color indicating the area having the predetermined luminance level; and
combining the first colored image and the second colored image and to output combined image data.

16. A method of controlling a signal processing apparatus, the method comprising:
acquiring image data obtained by capturing an image of an object and a background video image displayed on a background display by an imaging apparatus;
extracting information on an object area and information on a background video image area in the image data;
changing, when a pixel of the image data on the background video image area has chromaticity outside a predetermined color gamut, a color or brightness of the pixel;
changing, when a pixel of the image data on the object area has chromaticity outside a predetermined color gamut, a color or brightness of the pixel; and
combining image data output in the changing the color or brightness of the pixel of the image data on the background video image area and image data output in the changing the color or brightness of the pixel of the image data on the object area, and to output combined image data.

17. A non-transitory computer-readable storage medium storing a program for causing a computer to perform a method of controlling a signal processing apparatus, the method comprising:
acquiring image data obtained by capturing an image of an object and a background video image displayed on a background display by an imaging apparatus;
extracting information on an object area and information on a background video image area in the image data;
generating a first colored image in which an area including a first frequency component of the image data on the background video image area is colored with a specific color indicating the area including the first frequency component;
generating a second colored image in which an area including a second frequency component of the image data on the object area is colored with a specific color indicating the area including the second frequency component; and
combining the first colored image and the second colored image and outputting combined image data.
